(19) United States
(12) Patent Application Publication
(10) Pub. No.: US 2004/0047788 A1
(43) Pub. Date: Mar. 11, 2004

(54) Carbon monoxide removal from reformate gas

(76) Inventor: Mitsutaka Abe, Kanagawa (JP)

Correspondence Address: MCDERMOTT WILL & EMERY, 600 13TH STREET, N.W., WASHINGTON, DC, 20005-3096, US

(21) Appl. No.: 10/432,836

(22) PCT Filed: Jan. 15, 2003
(86) PCT No.: PCT/JP03/00240

(30) Foreign Application Priority Data
Feb. 8, 2002 (JP) 2002-32383

(51) Int. Cl. B01D 53/62; B01J 8/00; G05B 1/00

(52) U.S. Cl. 423/247; 422/105; 422/110; 422/172; 422/177

(57) ABSTRACT

Carbon monoxide in reformate gas is removed by oxidizing reactions in a plurality of catalytic components (4A-4C) disposed in series. Air from air supply valves (6A-6C) is supplied to the catalytic components (4A-4C). The oxidation amount of carbon monoxide in the catalytic components (4A-4C) depends on air supply flow rates of the air supply valves (6A-6C). A controller (7) controls the air supply valves (6A-6C) so that the ratio of the air supply flow rate to an upstream component (4A) with respect to the air supply flow rate to a downstream component (4C) decreases as a flow rate of reformate gas decreases. In this manner, reverse shift reactions generating carbon monoxide as a result of reactions between carbon dioxide and hydrogen contained in the reformate gas can be suppressed in the downstream catalytic component (4C) when the flow rate of reformate gas is low.

### FIELD OF THE INVENTION

This invention relates to the removal of carbon monoxide from reformate gas mainly containing hydrogen.

### BACKGROUND OF THE INVENTION

In order to remove carbon monoxide contained in reformate gas which mainly contains hydrogen, selectively reacting oxidizing agent with carbon monoxide on a catalyst is a known method. Further, it is also known to arrange a plurality of catalytic components in series with respect to the flow of reformate gas, and mix oxidizing agent into the reformate gas upstream of each catalytic component in order to optimize reaction efficiency.

Oxidation reactions of carbon monoxide are termed preferential oxidations. Preferential oxidations may be accompanied with reverse shift reactions which produce carbon monoxide depending on the reaction conditions. When the concentration of both the oxidizing agent and the carbon monoxide present in the reformate gas is low, reverse shift reactions are conspicuously promoted. Reverse shift reactions are particularly promoted in the downstream catalytic component where the concentration of carbon monoxide is low. When a reverse shift reaction occurs, the removal ratio for carbon monoxide is reduced.

Tokkai 2000-169106 published by the Japanese Patent Office in 2000 discloses a device for suppressing reverse shift reactions. A plurality of catalytic components are arranged as described above. A highly-active platinum (Pt) catalyst is disposed in the upstream catalytic component and an ruthenium (Ru) catalyst which displays lower activity is disposed in the downstream component. Reverse shift reactions which are apt to occur in the downstream catalytic component, or in the catalytic component in which the concentration of carbon monoxide is low, are suppressed through the use of the catalyst comprising relatively less reactive Ru.

### SUMMARY OF THE INVENTION

However, the carbon monoxide removal device according to this prior art also entails the problem that the oxidation potential of the downstream catalytic component comprising a relatively less reactive catalyst exceeds the actual oxidation amount when the flow rate of reformate gas is smaller than a predetermined amount. When the oxidation potential of the catalytic component exceeds the actual oxidation amount, oxidizing reactions are promoted leading to rapid consumption of the oxidizing agent. Consequently, in the catalytic components in which little amount of oxidizing agent remains, reverse shift reactions are apt to occur due to the low concentration of carbon monoxide and the oxidizing agent and carbon monoxide is thereby generated.

It is therefore an object of this invention to effectively suppress reverse shift reactions in a carbon monoxide removal device in which a plurality of catalytic components are disposed in series with respect to the direction of flow of reformate gas.

In order to achieve the above object, this invention provides a carbon monoxide removal device removing carbon monoxide contained in a reformate gas by catalyst-mediated oxidizing reactions using an oxidizing agent. The device comprises a catalytic reactor storing a catalyst and allowing passage of the reformate gas, the catalytic reactor comprising an upstream part and a downstream part disposed further downstream than the upstream part relative to the flow of the reformate gas and a programmable controller controlling oxidizing reactions in the catalytic reactor.

The controller is programmed to reduce a ratio of an oxidation amount in the upstream part with respect to an oxidation amount in the downstream part when a flow rate of the reformate gas falls below a predetermined value.

This invention also provides a carbon monoxide removal method for removing carbon monoxide contained in a reformate gas by catalyst-mediated oxidizing reactions by providing an oxidizing agent to a catalytic reactor storing a catalyst and allowing passage of the reformate gas wherein the catalytic reactor comprises an upstream part and a downstream part disposed further downstream than the upstream part relative to the flow of the reformate gas.

The method comprises controlling oxidizing reactions in the catalytic reactor to reduce a ratio of an oxidation amount in the upstream part with respect to an oxidation amount in the downstream part when a flow rate of the reformate gas falls below a predetermined value.

The details as well as other features and advantages of this invention are set forth in the remainder of the specification and are shown in the accompanying drawings.

### BRIEF DESCRIPTION OF THE DRAWINGS

FIG. 1 is a schematic diagram of a carbon monoxide removal device for a fuel cell power plant according to this invention.

FIGS. 2A and 2B are diagrams showing the relationship of air supply flow rates to the respective catalytic components and a load on the fuel cell power plant providing that air distribution ratios to the catalytic components of the device are fixed.

FIGS. 3A and 3B are diagrams showing the relationship of the air supply flow rates as well as the air distribution ratios to the catalytic components and the load on the fuel cell power plant, according to this invention.

FIG. 4 is a flowchart describing a routine for controlling air supply flow rates to the respective catalytic components executed by a controller according to this invention.

FIG. 5 is a diagram showing the relationship between carbon monoxide concentration at an outlet of the carbon monoxide removal device and the load on the fuel cell power plant.

FIGS. 6A and 6B are similar to FIGS. 3A and 3B, but showing a second embodiment of this invention.

FIG. 7 is similar to FIG. 1, but showing the second embodiment of this invention.

FIG. 8 is similar to FIG. 4, but showing the second embodiment of this invention.

FIG. 9 is a schematic diagram of a carbon monoxide removal device for a fuel cell power plant according to a third embodiment of this invention.

FIGS. 10A and 10B are similar to FIGS. 3A and 3B, but showing the third embodiment of this invention.

FIG. 11 is a flowchart describing a routine for controlling coolant supply flow rates to the respective components executed by a controller according to the third embodiment of this invention.

### DESCRIPTION OF THE PREFERRED EMBODIMENTS

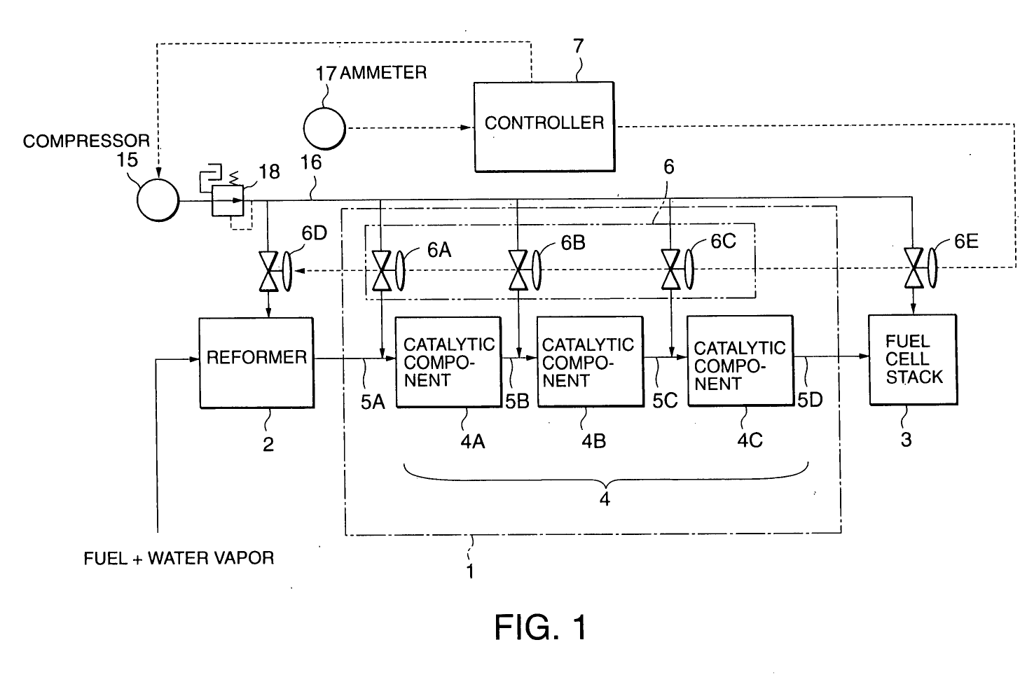

Referring to FIG. 1 of the drawings, a carbon monoxide removal device 1 removing carbon monoxide from reformate gas in a fuel cell power plant is provided between a reformer 2 and a fuel cell stack 3.

Fuel in the reformer 2 reacts with water vapor and air in order to produce a reformate gas. Representative examples of fuel are methanol and gasoline which mainly comprise hydrocarbons. The reformate gas mainly contains hydrogen, but it still contains carbon monoxide. For example, the reformate gas resulting from methanol contains approximately 1.5% carbon monoxide.

The fuel cell stack 3 performs power generation using known catalytic reactions between hydrogen-rich gas and air. In order to efficiently promote electro-chemical reactions, it is necessary that the catalyst in the fuel cell stack 3 is maintained in a preferred state. Carbon monoxide reduces the power generation performance of the fuel cell stack 3 by poisoning the catalyst. To prevent this non-preferable effect of carbon monoxide, the carbon monoxide removal device 1 removes carbon monoxide from the reformate gas and promotes hydrogen-rich gas of which a carbon monoxide concentration is of the order of 10 ppm.

The carbon monoxide removal device 1 is provided with a catalytic reactor 4 comprising three catalytic components 4A-4C disposed in series with respect to the flow of reformate gas.

The catalytic component 4A is disposed in upstream part of the catalytic reactor 4 and the catalytic components 4B, 4C are disposed further downstream than the catalytic component 4A in the catalytic reactor 4. Thus, the catalytic component 4A may be referred to as an upstream part of the catalytic reactor 4 and the catalytic components 4B, 4C may be referred to as a downstream part of thereof.

The catalytic reactor 4 is provided with an air supply valve 6A-6C supplying air as an oxidizing agent separately to the catalytic components 4A-4C.

Air is supplied from the air supply valve 6A to a pipe 5A connecting the reformer 2 with the catalytic component 4A disposed in the most upstream position. Air is supplied from the air supply valve 6B to a pipe 5B connecting the catalytic component 4A with the catalytic component 4B. Air is supplied from the air supply valve 6C to a pipe 5C connecting the catalytic component 4B with the catalytic component 4C. Hydrogen-rich gas processed in the catalytic component 4C is supplied to the fuel cell stack 3 through a pipe 5D.

Air is also supplied to the reformer 2 through an air supply valve 6D. In addition, air is supplied to the fuel cell stack 3 through an air supply valve 6E. Each air supply valve 6A-6E is connected in parallel to an air supply pipe 16. Air is supplied at a fixed pressure to the air supply pipe 16 through a pressure control valve 18 from a compressor 15. The air supply valves 6A-6E vary the openings in response to signals from the controller 7.

The controller 7 comprises a microcomputer provided with a central processing unit (CPU), a read-only memory (ROM), a random access memory (RAM) and an input/output interface (I/O interface). The controller 7 may comprise a plurality of microcomputers.

The controller 7 uses the air supply valves 6A-6E to control the flow rates of supplied air in response to the flow rate of reformate gas produced by the reformer 2. The flow rate of reformate gas is proportional to the power generation load on the fuel cell power plant. Furthermore the power generation load on the fuel cell power plant is proportional to the output current of the fuel cell stack 3. For this purpose, a signal representing the output current of the fuel cell stack 3 is input into the controller 7 from an ammeter 17 as a signal corresponding to the flow rate of reformate gas.

It should be noted however that various options exist for values which represent the flow rate of reformate gas. These options include direct measurement of the flow rate of reformate gas supplied from the reformer 2.

Catalyst is provided in each catalytic component 4A-4C. The catalyst principally comprises platinum/aluminum oxide (Pt/Al₂O₃) which is known to selectively oxidize carbon monoxide.

Although three catalytic components 4A-4C are used in this embodiment, the number of catalytic components need only be plural and is not limited to three. Furthermore it is possible to provide a single catalytic component, and to provide a plurality of supply ports for oxidizing agent at a plurality of points along the length of the passage for reformate gas in the catalytic component.

Carbon monoxide is removed from the reformate gas in the catalytic component 4A-4C using preferential oxidations between oxygen in the air and the reformate gas as shown by the chemical Equation (1) below.

2CO+O₂→2CO₂ (1)

However the reaction shown in Equation (1) may be accompanied with an undesirable sub-reaction, i.e., reverse shift reaction represented by the chemical Equation (2) below, depending on reaction conditions of the Pt/Al₂O₃ catalyst.

CO₂+H₂→CO+H₂O (2)

The reverse shift reaction consumes hydrogen and produces carbon monoxide as clearly shown in Equation (2). This reaction is opposite to the objective of the carbon monoxide removal device 1.

When an excess of oxygen is present in the reformate gas, chemical reactions as shown by Equation (1) are promoted. As a result, when oxygen in the reformate gas becomes insufficient, the reaction shown by Equation (2) tends to dominate. On the basis of the principle of chemical equilibrium, the reaction shown in Equation (2) dominates further when the concentration of carbon monoxide is low.

The overall oxidation potential of the catalytic reactor 4 is normally designed to cope with a load during rated operation of the fuel cell power plant, that is to say, to cope with a maximum load under which the power plant can operate stably. The overall oxidation potential of the catalytic reactor 4 means the maximum oxidation amount under conditions in which the temperature of the catalytic components 4A-4C is maintained in a temperature region not higher than 200° C., which corresponds to a temperature region where the reaction of Equation (2) does not predominate.

When the operating load of the fuel cell power plant is less than the predetermined value, or the rated value, the amount of reformate gas produced is also low and the absolute amount of carbon monoxide contained in the reformate gas also decreases. As a result, the oxidation potential of the catalytic components 4A-4C is excessive when compared with the amount of carbon monoxide to be removed.

In this situation, however, not all of the catalytic components 4A-4C have excessive oxidation potential, but only the catalytic components located upstream have excessive oxidation potential. In other words, the preferential oxidation shown in Equation (1) predominates in the upstream catalytic component 4A in which the concentration of carbon monoxide is high. In the downstream catalytic component 4C, the reverse shift reaction shown in Equation (2) predominates.

It is thought that the reverse shift reaction in the downstream catalytic component 4C can be suppressed by setting the preferential oxidation amount in the downstream catalytic component 4C to a value smaller than the preferential oxidation amounts in the other catalytic components 4A, 4B.

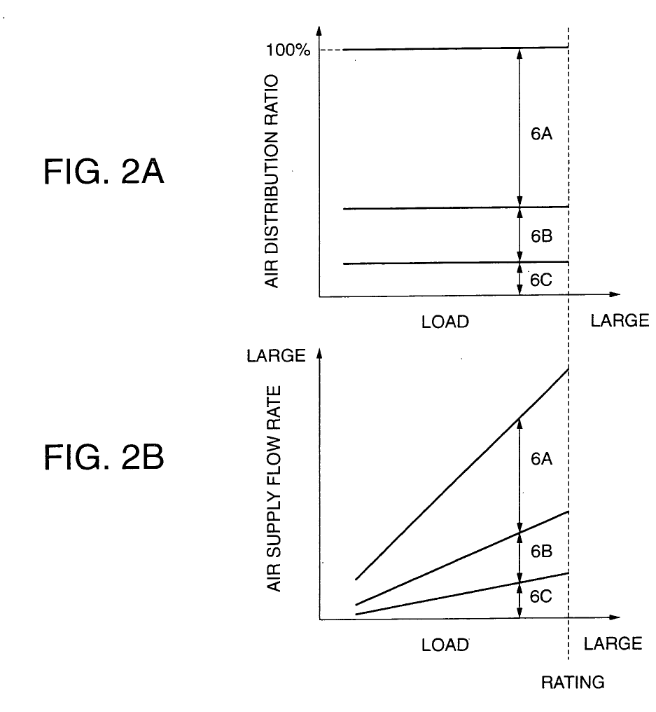

Referring to FIGS. 2A and 2B, a case where the preferential oxidation amount in the catalytic component 4A located upstream is always larger than the preferential oxidation amount in the catalytic component 4C located downstream will be considered.

The air supply flow rate required by each catalytic component 4A-4C is proportional to the preferential oxidation amount In order to fix the air distribution ratio in the air supply valves 6A-6C irrespective of the operating load of the fuel cell power plant as shown in FIG. 2A, it is necessary to vary the air supply flow rates of the respective air supply valves 6A-6C in response to the operating load of the fuel cell power plant as shown in FIG. 2B.

However, even if these air supply flow rates are controlled in this way, when the operating load of the fuel cell power plant falls below the rated value, the reverse shift reactions may still dominate in the downstream catalytic component 4C which has a low carbon monoxide concentration.

Although the description above is related to the upstream catalytic component 4A and the downstream catalytic component 4C, the same relationship may be created between the upstream catalytic component 4A and the middle catalytic component 4B.

This invention prevents reverse shift reactions from occurring even when the operating load of the fuel cell power plant falls below the predetermined value, or rated value, by preventing the oxidation amount of the downstream catalytic component 4C from becoming small. More precisely, the amount of carbon monoxide flowing into the downstream catalytic component 4C is relatively increased to meet the oxidation potential of the catalytic component 4C by suppressing the oxidation amount in the upstream catalytic component 4A.

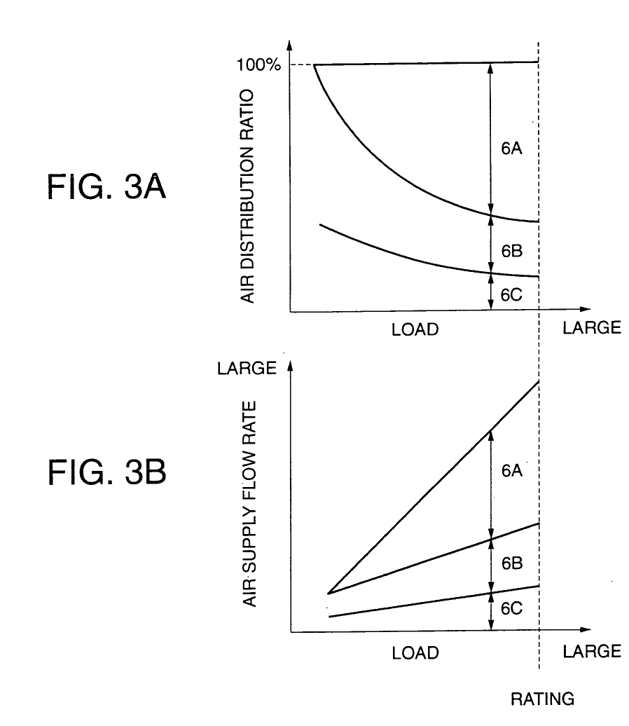

Referring to FIGS. 3A and 3B, this invention creates the conditions referred to above by decreasing the air distribution ratio of the catalytic component 4A and increasing the air distribution ratio to the catalytic components 4B and 4C. In this manner, the relative amount of carbon monoxide removed in the upstream catalytic component 4A during low load is decreased and the relative amounts of carbon monoxide removed in the catalytic components 4B, 4C is increased.

For this reason, the air supply flow rates to the catalytic components 4B, 4C are set as shown in FIG. 3B. As shown in the figure, the air supply flow rate to the catalytic component 4C still decreases as the load on the fuel cell power plant decreases in spite of the increase in the air distribution ratio thereof. This maintains a preferred removal efficiency for carbon monoxide for the following reason. In low-load operating regions of the fuel cell power plant in which the air concentration in the reformate gas is relatively high, the temperature of the catalytic component sharply rises as a result of oxidizing reactions mediated by the highly-reactive Pt/Al₂O₃ catalyst. However temperature increases reduce the removal efficiency for carbon monoxide in the catalytic component. The air supply flow rate to the downstream catalytic component 4C is limited to a value corresponding to the reduction in the load on the fuel cell power plant so that the temperature of the catalytic component 4C is also suppressed so as not to exceed 200° C. when the load on the fuel cell power plant decreases. The amount of oxidation enabled by the air supply flow rate after the limiting process therefore represents the oxidation potential of the catalytic component 4C with respect to the load on the fuel cell power plant or the flow rate of reformate gas.

In the same manner, the air supply flow rate to the catalytic component 4B is set in response to the load on the fuel cell power plant. The air supply flow rate to the catalytic component 4A is determined by subtracting the sum of the air supply flow rates to the catalytic components 4B and 4C determined in the above manner from the total air supply flow rate required for carbon monoxide removal in the entire catalytic reactor 4.

As a result, the distribution ratio of air to the catalytic components 4A-4C decreases in the upstream catalytic component 4A and increases in the downstream catalytic components 4B and 4C, as the load on the fuel cell power plant decreases. As shown in the figure, the air supply flow rate to the upstream catalytic component 4A is approximately zero when the load on the fuel cell power plant is the minimum.

The controller 7 is provided with a map which is pre-stored in the memory in order to realize control of the air supply flow rates as described above. This map determines the relationship between the load on the fuel cell power plant and the flow rate of each air supply valve 6A-6C. A calculation formula or a table may be used instead of the map.

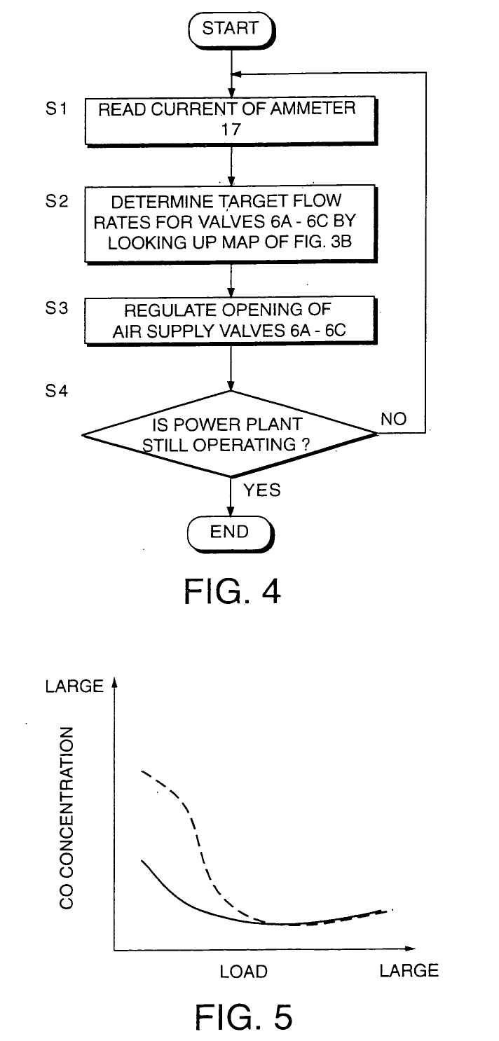

With this map, the controller 7 executes a routine shown in FIG. 4. This routine is initiated at the same time as the fuel cell power plant is activated.

Firstly in a step S1, the controller 7 reads the detected current of the ammeter 17 as a representative value for the load on the fuel cell power plant. It is possible to use various other values as a representative value for the load on the fuel cell power plant. For example, in order to represent the current output from the fuel cell stack 3, it is possible to use a target current value set by a controller in another unit controlling the fuel cell power plant instead of using the ammeter 17. It is also possible to use a flow rate F_{H2} for hydrogen-rich gas supplied to the fuel cell stack 3 as the representative value for the load on the fuel cell power plant. The flow rate F_{H2} can be detected by installing a flow meter in the pipe 5D.

Then in a step S2, based on the representative value for the load, the controller 7 determines the respective target air flow rates for the air supply valves 6A-6C by referring to a map stored in the memory as shown in FIG. 3B.

Then in a step S3 the controller 7 controls the opening of each air supply valve 6A-6C in order to realize the target air flow rate for this purpose, the controller 7 stores a map defining the flow rates and openings of the air supply valves 6A-6C and calculates the openings of the air supply valves 6A-6C from the map. Alternatively the actual flow rates of the air supply valves 6A-6C may be respectively detected using sensors and the actual flow rates can be feedback controlled to coincide with the target air flow rates.

In a step S4, the controller 7 determines whether or not the operation of the fuel cell power plant is continuing. This determination is performed using a signal from the aforesaid controller of the fuel cell power plant or a signal from a key switch commanding the startup and stoppage of the fuel cell power plant.

In the step S4, when the operation of the fuel cell power plant is continuing, that is to say, when an operation termination command has not been generated, the controller 7 repeats the process in the steps S1 to S4. On the other hand in the step S4, when the operation of the fuel cell power plant is not continuing, that is to say, the operation termination command has been generated, the controller 7 immediately terminates the routine.

In the above routine, if a direct correlation between the opening of each air supply valve 6A-6C and the load on the fuel cell power plant can be defined, it is possible to omit the process in the step S2 by storing a map showing that correlation in the memory.

The result of the above control is that almost no preferential oxidations occur in the upstream catalytic component 4A when the load on the fuel cell power plant is small. However since the concentration of carbon monoxide in the reformate gas is high in the upstream catalytic component 4A, even when the preferential oxidation shown in Equation (1) is not performed, the reverse shift reaction shown in Equation (2) occurs at an extremely slow rate or does not occur at all due to chemical equilibrium.

In other words, in regions of low load on the fuel cell power plant in which the carbon monoxide oxidation potential of the catalytic components 4A-4C is in excess, the controller 7 removes carbon monoxide only in the middle catalytic component 4B and the downstream catalytic component 4C in order to prevent the excess oxidation potential from causing reverse shift reactions.

When the air supply flow rates are controlled under the above control conditions, the carbon monoxide concentration at the outlet of the carbon monoxide removal device 1 shows a variation as indicated by the solid line in FIG. 5. In contrast, the carbon monoxide concentration at the outlet of the carbon monoxide removal device 1 when the air distribution ratio is fixed as shown in FIG. 2A or 2B shows a variation as indicated by the broken line in FIG. 5. As clearly shown in the figure, the control on the supplied air flow amount due to this invention achieves the result of improving the carbon monoxide removal performance in low-load regions of the fuel cell power plant.

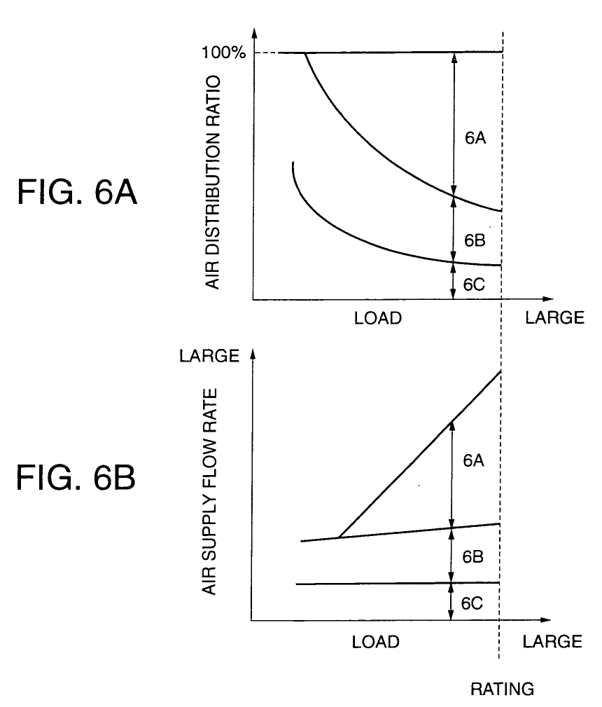

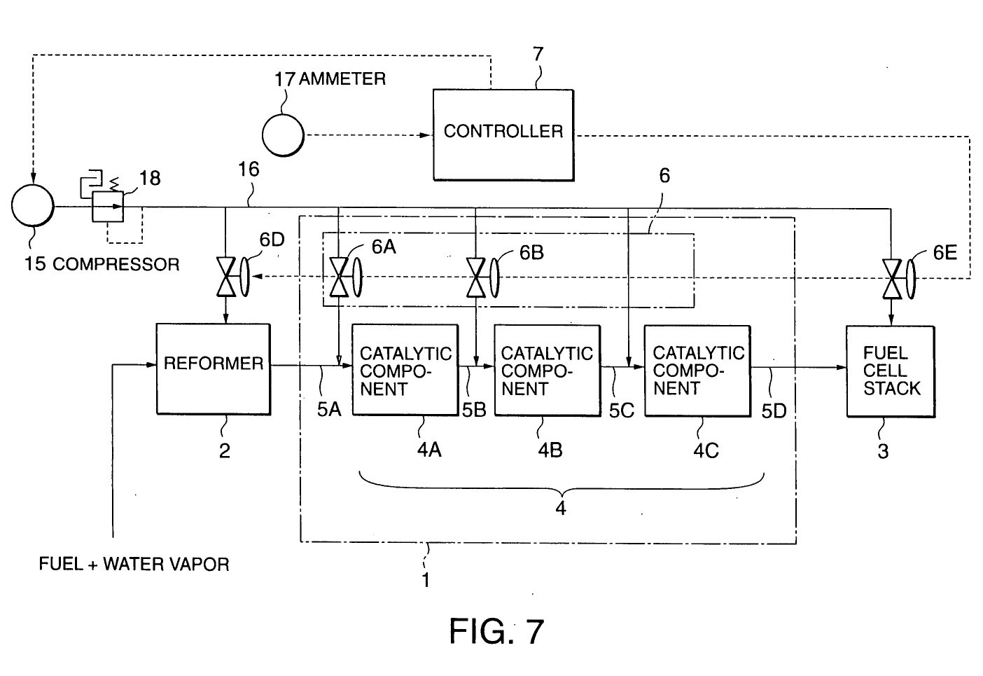

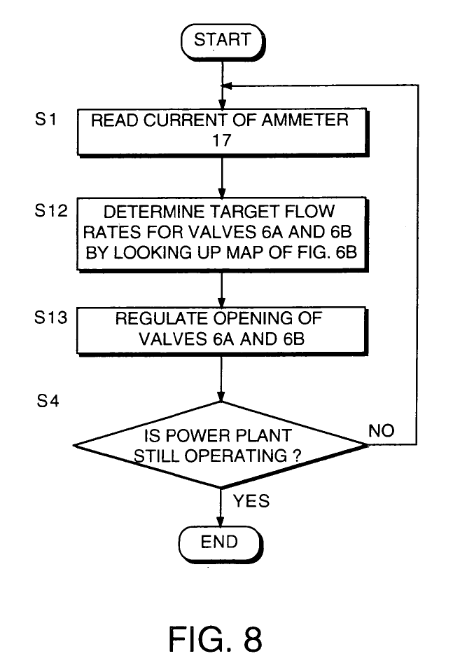

A second embodiment of this invention will be described hereafter referring to FIGS. 6A and 6B and FIGS. 7 and 8.

In the first embodiment, the air supply flow rate to the catalytic component 4C is set so that the absolute amount decreases corresponding to decreases in the load on the fuel cell power plant although the air distribution ratio increases. This setting is applied in order to avoid excessive increase in the temperature of the catalytic component 4C as described above.

In this embodiment, in order to avoid excessive temperature increase in the catalytic component 4C, catalyst having relatively low reactivity is used in the catalytic component 4C. Specifically, Pt/Al₂O₃ catalyst which is the same as that used in the first embodiment is used in the catalytic components 4A and 4B. In contrast, Ru/Al₂O₃ catalyst containing ruthenium (Ru) is used in the catalytic component 4C.

Referring to FIGS. 6A and 6B, in this embodiment, the air supply flow rate to the catalytic component 4C is maintained at a fixed value irrespective of decreases in the load on the fuel cell power plant. As a result, increase in the air distribution ratio of the catalytic component 4C resulting from decrease in the load on the fuel cell power plant is greater than that described in the first embodiment.

Referring to FIG. 7, the air supply valve 6C is omitted from the carbon monoxide removal device according to this embodiment. According to this embodiment, the air supply flow rate to the catalytic component 4C is fixed without reference to the load on the fuel cell power plant. The structure of hardware in the carbon monoxide removal device in other respects is the same as that described with reference to the first embodiment. The controller 8 executes a routine shown in FIG. 8 instead of the routine shown in FIG. 4 in order to control the supplied air flow amount.

The step S1 and the step S4 are the same as the routine shown in FIG. 4.

In a step S12 which follows the step S1, the controller 7 determines the respective target air flow rates for the air supply valves 6A and 6B based on the load on the fuel cell power plant by looking up a map having the characteristics shown in FIG. 6B which is pre-stored in the memory.

Then in a step S13, the opening of the air supply valves 6A and 6B is regulated so that the target air flow rate is realized. After the process in the step S13, the controller 7 performs the process in the step S4.

According to this embodiment, since the air supply valve 6C is omitted, the structure of the carbon monoxide removal device is simplified.

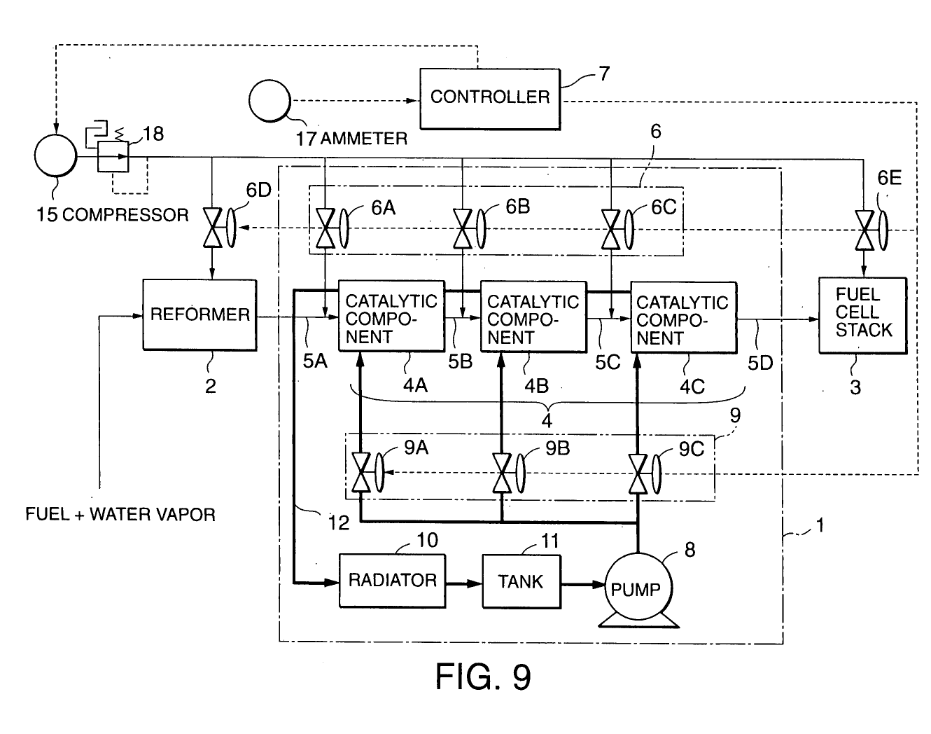

A third embodiment of this invention will now be described referring to FIGS. 9-11.

In this embodiment, a cooling device is provided in order to cool the catalytic components 4A-4C in addition to the structure of the first embodiment.

Referring to FIG. 9, the cooling device comprises a tank 11 storing coolant, a pump 8 pressurizing the coolant in the tank 11, coolant supply valves 9A-9C distributing the coolant discharged from the pump 8 to the catalytic components 4A-4C, a recirculation passage 12 which recirculates the coolant that has cooled the catalytic components 4A-4C to the tank 11, and a radiator 10 causing heat to radiate from the coolant in the recirculation passage 12.

When the fuel cell power plant is mounted in a vehicle as a source of drive force, it is possible to use water that has been used to cool the engine of the vehicle in a conventional manner as the coolant of the catalytic components 4A-4C. Instead of the radiator 10, it is possible to use a heat exchanger performing heat exchange between coolant and the fuel cell stack 3.

The coolant in the tank 11 is pressurized by the pump 8 and cools each catalytic components 4A-4C through the coolant supply valve 9A-9C. After cooling the catalytic components 4A-4C, the coolant is discharged into the common recovery passage 12 and radiates heat absorbed from the catalytic components 4A-4C in the radiator 10. Thereafter it is recirculated to the tank 11.

The pump 8 comprises a variable capacity pump in which the capacity, in other words, the discharge flow rate is controlled by a controller 7. The amounts of heat generated in the catalytic components 4A-4C depend on the oxidation amounts in the catalytic components 4A-4C. The oxidation amounts in turn depend on the air supply flow rates to the catalytic components 4A-4C. Thus the controller 7 determines a target coolant discharge flow rate depending on the total air supply flow rates to the catalytic components 4A-4C. Subsequently, the coolant discharge flow rate of the pump 8 is controlled in order to obtain the target coolant discharge flow rate.

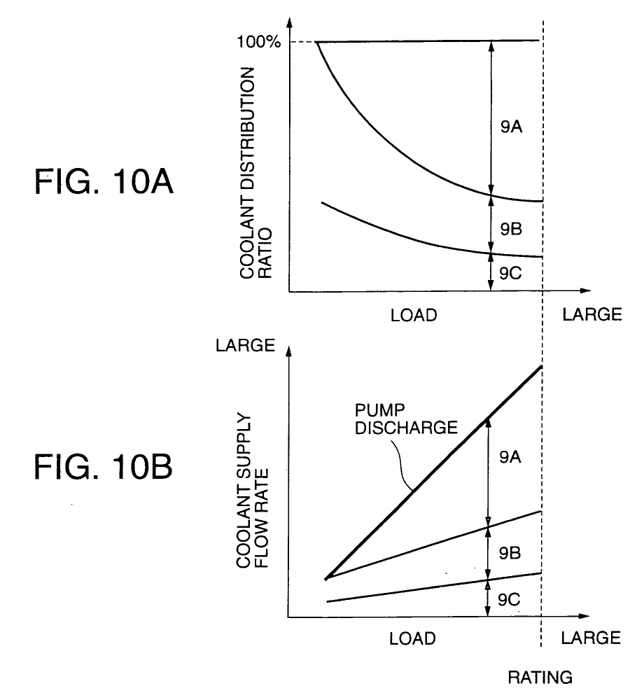

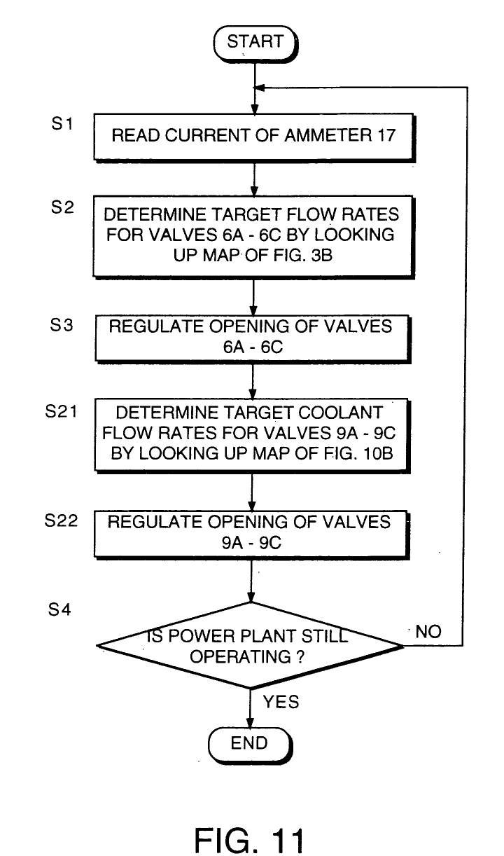

The controller 7 further determines a target coolant flow rate supplied to each catalytic components 4A-4C using the method described hereafter. Referring to FIGS. 10A and 10B, the target coolant supply flow rate of each cooling medium supply valve 9A-9C is set so as to be reduced as the operating load on the fuel cell power plant decreases. For this purpose, the memory of the controller 7 stores a map having the characteristics shown in FIG. 10B.

However this map is set so that the coolant distribution ratio to the downstream catalytic component 4C undergoes a relative increase as the operating load on the fuel cell power plant decreases.

Next referring to FIG. 11, a routine for controlling the air supply flow rates and the coolant supply flow rates executed by the controller 7 in this embodiment will be described. This routine is initiated at the same time as the fuel cell power plant is activated as in the case of the first and second embodiments.

The control of the air supply flow rates according to the steps S1-S4 is the same as the routine in FIG. 4 according to the first embodiment. In other words, the opening of each air supply valve 6A-6C is controlled using a map having the characteristics of the map shown in FIG. 3B.

After controlling the openings of the air supply valves 6A-6C in the step S3, the controller 7 proceeds to a step S21 and sets the target coolant supply flow rate for each coolant supply valve 9A-9C in response to the load on the fuel cell power plant by looking up a map having the characteristics shown in FIG. 10B which is pre-stored in the memory.

Then in a step S22, the controller 7 controls the opening of each coolant supply valve 9A-9C so that the target coolant supply flow rate is realized. This control is similar to the control of the air supply valves 6A-6C and can be performed by applying either open loop control or feedback control.

After the process in the step S22, the controller 22 performs the process in the step S4 in the same manner as in the first embodiment.

In this embodiment, since the catalytic components 4A-4C are cooled, it is possible to suppress temperature increases in the catalytic components 4A-4C resulting from oxidizing reactions irrespective of the load on the fuel cell power plant. Thus it is also possible to determine the flow amount of air supplied to the catalytic components 4A-4C without taking into account the suppression of temperature increases.

The contents of Tokugan 2002-32383, with a filing date of Feb. 8, 2002 in Japan, are hereby incorporated by reference.

Although the invention has been described above by reference to certain embodiments of the invention, the invention is not limited to the embodiments described above. Modifications and variations of the embodiments described above will occur to those skilled in the art, in light of the above teachings.

### INDUSTRIAL FIELD OF APPLICATION

As described above, this invention allows effective prevention of reverse shift reactions in a carbon monoxide removal device for reformate gas. Reverse shift reactions tend to occur in downstream catalytic components when the flow rate of the reformate gas is small. This invention therefore brings a particularly preferred effect when applied to a fuel cell power plant for a vehicle in which the flow amount of reformate gas undergoes large fluctuation in response to load.

The embodiments of this invention in which an exclusive property or privilege is claimed are defined as follows:

1. A carbon monoxide removal device removing carbon monoxide contained in a reformate gas by catalyst-mediated oxidizing reactions using an oxidizing agent, comprising:
a catalytic reactor (4) storing a catalyst and allowing passage of the reformate gas, the catalytic reactor (4) comprising an upstream part (4A) and a downstream part (4B, 4C) disposed further downstream than the upstream part (4A) relative to the flow of the reformate gas; and
a programmable controller (7) controlling oxidizing reactions in the catalytic reactor (4) programmed to:
reduce a ratio of an oxidation amount in the upstream part (4A) with respect to an oxidation amount in the downstream part (4B, 4C) when a flow rate of the reformate gas falls below a predetermined value (S2, S3, S12, S13).

2. The carbon monoxide removal device as defined in claim 1, wherein the carbon monoxide removal device further comprises an oxidizing agent supply mechanism (6A-6C, 15, 16, 18) which supplies the oxidizing agent separately to the upstream part (4A) and the downstream part (4B, 4C), and the controller (7) is further programmed to reduce the ratio of the oxidation amount in the upstream part (4A) with respect to the oxidation amount in the downstream part (4B, 4C) by controlling the oxidizing agent supply mechanism (6A-6C, 15, 16, 18) to decrease a ratio of a supply amount of the oxidizing agent to the upstream part (4A) with respect to a supply amount of the oxidizing agent to the downstream part (4B, 4C) (S2, S3, S12, S13).

3. The carbon monoxide removal device as defined in claim 2, wherein the oxidizing agent supply mechanism (6A-6C, 15, 16, 18) comprises a supply passage of the oxidizing agent (16) and an oxidizing agent supply valve (6A) which distributes the oxidizing agent from the supply passage (16) into the upstream part (4A), and the controller (7) is further programmed to reduce the ratio of the oxidation amount in the upstream part (4A) with respect to the oxidation amount in the downstream part (4B, 4C) by controlling an opening of the oxidizing agent supply valve (6A).

4. The carbon monoxide removal device as defined in claim 2 or claim 3, wherein the controller (7) is further programmed to determine a target supply amount of the oxidizing agent to the downstream part (4B, 4C) and a target supply amount of the oxidizing agent to the upstream part (4A) so that an amount of carbon monoxide flowing into the downstream part (4B, 4C) corresponds to an oxidation potential of the downstream part (4B, 4C) (S2, S12), and control the oxidizing agent supply mechanism (6A-6C, 15, 16, 18) to cause a supply amount of the oxidizing agent to the downstream part (4B, 4C) to coincide with the target supply amount of oxidizing agent to the downstream part (4B, 4C) and to cause a supply amount of the oxidizing agent to the upstream part (4A) to coincide with the target supply amount of the oxidizing agent to the upstream part (4A) (S3).

5. The carbon monoxide removal device as defined in claim 2 or claim 3, wherein the controller (7) is further programmed to determine the ratio of the oxidation amount in the upstream part (4A) with respect to the oxidation amount in the downstream part (4B, 4C) so as to prevent a temperature of the downstream part (4B, 4C) from exceeding a predetermined temperature due to oxidizing reactions in the downstream part (4B, 4C) (S2).

6. The carbon monoxide removal device as defined in claim 5, wherein the controller (7) is further programmed to reduce the supply amount of the oxidizing agent to the downstream part (4B, 4C) so as to prevent the temperature of the downstream part (4B, 4C) from exceeding the predetermined temperature due to oxidizing reactions in the downstream part (4B, 4C) (S2).

7. The carbon monoxide removal device as defined in claim 2 or claim 3, wherein the catalyst in the downstream part (4B, 4C) has a lower reactivity than the catalyst in the upstream part (4A), and the controller (7) is further programmed to control the oxidizing agent supply mechanism (6A-6C, 15, 16, 18) so that the supplied amount of the oxidizing agent to the downstream part (4B, 4C) does not vary irrespective of the flow rate of the reformate gas (S12).

8. The carbon monoxide removal device as defined in claim 2 or claim 3, wherein the carbon monoxide removal device further comprises a cooling device (8, 9A-9C, 10, 11, 12) which cools the catalytic reactor (4).

9. The carbon monoxide removal device as defined in claim 8, wherein the cooling device (8, 9A-9C, 10, 11, 12) comprises a coolant supply valve (9A-9C) which can individually supply coolant to the downstream part (4B, 4C) and the upstream part (4A), and the controller (7) is further programmed to determine a target supply amount of the coolant to the upstream part (4A) and a target supply amount of the coolant to the downstream part (4B, 4C) in response to the flow rate of the reformate gas (S21), and control the coolant supply valve (9A-9C) to cause a supply amount of the coolant to the upstream part (4A) to coincide with the target supply amount of the coolant to the upstream part (4A) and to cause a supply amount of the coolant to the downstream part (4B, 4C) to coincide with the target supply amount of the coolant to the downstream part (4B, 4C).

10. The carbon monoxide removal device as defined in claim 2 or claim 3, wherein the controller (7) is further programmed to reduce further the ratio of the supply amount of the oxidizing agent to the upstream part (4A) with respect to the supply amount of the oxidizing agent to the downstream part (4B, 4C), as the flow rate of the reformate gas decreases from the predetermined value (S2, S12).

11. The carbon monoxide removal device as defined in claim 3, wherein the oxidizing agent is air, and the oxidizing agent supply mechanism (6A-6C, 15, 16, 18) comprises a pressure regulation mechanism which maintains a pressure of the air at a fixed pressure.

12. The carbon monoxide removal device as defined in any one of claim 2, claim 3 and claim 11, wherein the carbon monoxide removal device is disposed in a passage (5A, 5D) which supplies the reformate gas to a fuel cell stack (3) of a fuel cell power plant, the carbon monoxide removal device further comprises a load detection sensor (17) which detects a power generation load on the fuel cell power plant as a value representing the flow rate of the reformate gas, and the controller (7) is further programmed to reduce the ratio of the oxidation amount in the upstream part (4A) with respect to the oxidation amount in the downstream part (4B, 4C) when the power generation load falls below a predetermined load (S2, S3, S12, S13).

13. The carbon monoxide removal device as defined in claim 12, wherein the load detection sensor (17) comprises an ammeter (17) detecting an output current of the fuel cell stack (3).

14. The carbon monoxide removal device as defined in claim 12, wherein the controller (7) stores a map presetting a target supply amount of the oxidizing agent to the downstream part (4B, 4C) and a target supply amount of the oxidizing agent to the upstream part (4A) in response to the power generation load on the fuel cell power plant, and is further programmed to determine the target supply amount of the oxidizing agent to the downstream part (4B, 4C) and the target supply amount of the oxidizing agent to the upstream part (4A) by looking up the map based on the detected power generation load (S2, S12), and control the oxidizing agent supply mechanism (6A-6C, 15, 16, 18) to cause a supply amount of the oxidizing agent to the upstream part (4A) to coincide with the target supply amount of the oxidizing agent to the upstream part (4A) and to cause a supply amount of the oxidizing agent to the downstream part (4B, 4C) to coincide with the target supply amount of the oxidizing agent to the downstream part (4B, 4C) (S3, S13).

15. A carbon monoxide removal device removing carbon monoxide contained in a reformate gas by catalyst-mediated oxidizing reactions using an oxidizing agent, comprising:
a catalytic reactor (4) storing a catalyst and allowing passage of the reformate gas, the catalytic reactor (4) comprising an upstream part (4A) and a downstream part (4B, 4C) disposed further downstream than the upstream part (4A) relative to the flow of the reformate gas; and
means (7, S2, S3, S12, S13) for controlling oxidizing reactions in the catalytic reactor (4) to reduce a ratio of an oxidation amount in the upstream part (4A) with respect to an oxidation amount in the downstream part (4B, 4C) when a flow rate of the reformate gas falls below a predetermined value.

16. A carbon monoxide removal method for removing carbon monoxide contained in a reformate gas by catalyst-mediated oxidizing reactions by providing an oxidizing agent to a catalytic reactor (4) storing a catalyst and allowing passage of the reformate gas, the catalytic reactor (4) comprising an upstream part (4A) and a downstream part (4B, 4C) disposed further downstream than the upstream part (4A) relative to the flow of the reformate gas; the method comprising:
controlling oxidizing reactions in the catalytic reactor (4) to reduce a ratio of an oxidation amount in the upstream part (4A) with respect to an oxidation amount in the downstream part (4B, 4C) when a flow rate of the reformate gas falls below a predetermined value (S2, S3, S12, S13).
